(19) United States
(12) Patent Application Publication
(10) Pub. No.: US 2026/0089226 A1
(43) Pub. Date: Mar. 26, 2026

(54) INFORMATION PROCESSING APPARATUS, INFORMATION PROCESSING METHOD, AND NON-TRANSITORY COMPUTER READABLE MEDIUM

(71) Applicant: JVCKENWOOD Corporation, Yokohama-shi (JP)

(72) Inventor: Mizuki OHARA, Yokohama-shi (JP)

(21) Appl. No.: 19/299,067

(22) Filed: Aug. 13, 2025

(30) Foreign Application Priority Data
Sep. 24, 2024 (JP) 2024-165302

(51) Int. Cl. H04L 67/51; G06T 11/20

(52) U.S. Cl. CPC H04L 67/51; G06T 11/26

(57) ABSTRACT

An information processing apparatus includes: an acquisition unit configured to acquire a plurality of tracks; a tree drawing unit configured to draw a tree diagram with the tracks as nodes; and a group editing unit configured to edit a plurality of tracks that are shared in a group including a plurality of users and are derived from a certain track in such a way that the plurality of tracks are not open to an outside of the group. The group editing unit selects one or more public tracks to be open to the outside of the group from among the plurality of tracks edited in such a way that the plurality of tracks are not open to the outside of the group, and the tree drawing unit draws the tree diagram based on the one or more public tracks selected by the group editing unit.

### CROSS REFERENCE TO RELATED APPLICATION

This application is based upon and claims the benefit of priority from Japanese patent application No. 2024-165302, filed on Sep. 24, 2024, the disclosure of which is incorporated herein in its entirety by reference.

### BACKGROUND

The present disclosure relates to an information processing apparatus, an information processing method, and a program.

A music production system for stacking a plurality of tracks to produce one piece of music has been known. In this music production system, a user posts a track that he/she has produced on a predetermined website via the Internet or the like. The posted track is, for example, drawn in a tree diagram as one node. As another track to be stacked on the posted track is newly posted, a plurality of nodes are connected by a branch, whereby a tree diagram is formed.

As related art, Patent Literature 1 discloses a content production support system capable of grouping information on materials for producing content and forming a structure thereof in a tree-like structure. This content production support system regards each node of the tree as one basic unit of information, and causes each basic unit of information to be stored in a recording unit as a complex of various kinds of data and means for handling these data items.

[Patent Literature 1] Japanese Unexamined Patent Application Publication No. 2006-285465

### SUMMARY

In the aforementioned music production system, there is a case where a plurality of users form one group and the group members produce a track together. Each member can participate in production of the track within the group by asking, for example, other members for their opinions about the track he/she has produced or by giving his/her opinions about tracks produced by other members.

The track produced in the group is posted on a website by any one of the members (e.g., a representative of a group), like tracks produced by individual persons. Therefore, it may be impossible to determine, on the tree diagram, whether the track is produced by a group or by an individual person. Further, it may be desirable to open the process of track production in the group only within the group, not to open the process of track production to the outside of the group.

An information processing apparatus according to one aspect of the present disclosure includes: an acquisition unit configured to acquire a plurality of tracks; a tree drawing unit configured to draw a tree diagram with the tracks as nodes; and a group editing unit configured to edit a plurality of tracks that are shared in a group including a plurality of users and are derived from a certain track in such a way that the plurality of tracks are not open to an outside of the group, in which the group editing unit selects one or more public tracks to be open to the outside of the group from among the plurality of tracks edited in such a way that the plurality of tracks are not open to the outside of the group, and the tree drawing unit draws the tree diagram based on the one or more public tracks selected by the group editing unit.

An information processing method according to one aspect of the present disclosure includes: an acquisition step of acquiring a plurality of tracks; a tree drawing step of drawing a tree diagram with the tracks as nodes; and a group editing step of editing a plurality of tracks that are shared in a group including a plurality of users and are derived from a certain track in such a way that the plurality of tracks are not open to an outside of the group, in which in the group editing step, one or more public tracks to be open to the outside of the group are selected from among the plurality of tracks edited in such a way that the plurality of tracks are not open to the outside of the group, and in the tree drawing step, the tree diagram is drawn based on the one or more public tracks selected in the group editing step.

A program according to one aspect of the present disclosure causes a computer to execute: an acquisition step of acquiring a plurality of tracks; a tree drawing step of drawing a tree diagram with the tracks as nodes; and a group editing step of editing a plurality of tracks that are shared in a group including a plurality of users and are derived from a certain track in such a way that the plurality of tracks are not open to an outside of the group, in which in the group editing step, one or more public tracks to be open to the outside of the group are selected from among the plurality of tracks edited in such a way that the plurality of tracks are not open to the outside of the group, and in the tree drawing step, the tree diagram is drawn based on the one or more public tracks selected in the group editing step.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing an overall configuration of a music production system;

FIG. 2 is a diagram showing a flow from a time when a track is produced to a time when it is published on a tree diagram;

FIG. 3 is a block diagram showing a functional configuration of an information processing apparatus;

FIG. 4 is a block diagram showing a functional configuration of a terminal apparatus;

FIG. 5 is a flowchart showing a flow of tree diagram drawing processing performed by the information processing apparatus;

FIG. 6 shows one example of a basic tree diagram drawn in tree diagram drawing processing performed by the information processing apparatus;

FIG. 7 is a flowchart showing a flow of track publishing processing performed by the information processing apparatus;

FIG. 8 shows one example of a tree diagram drawn in a tree drawing unit;

FIG. 9 shows one example of a tree diagram when a public track is published as a group track; and

FIG. 10 shows one example of a tree diagram when a public track is published as a personal track in the group.

### DETAILED DESCRIPTION

Hereinafter, embodiments of the present disclosure will be described in detail below with reference to the drawings. In each drawing, the same or corresponding elements have the same reference numerals. Repeated descriptions are omitted as necessary for clarity of the description.

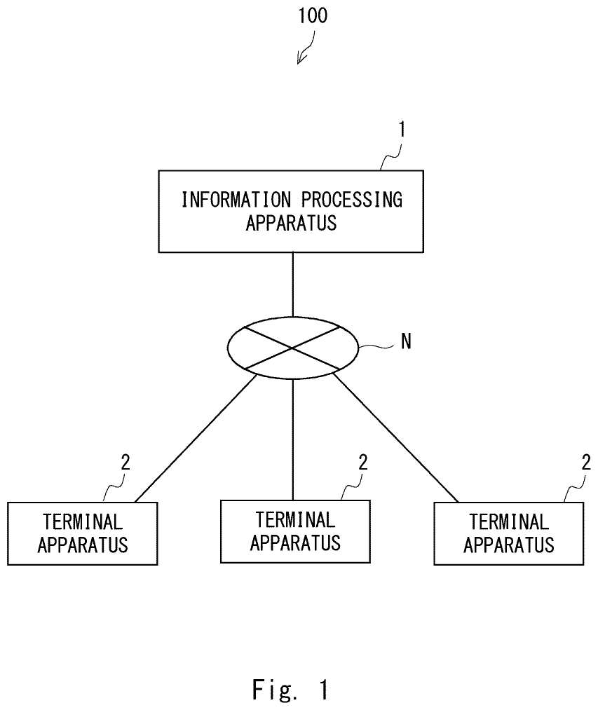

(Overall Configuration of Music Production System 100) With reference to FIG. 1, an overall configuration of a music production system 100 according to this embodiment will be described. FIG. 1 is a block diagram showing the overall configuration of the music production system 100.

The music production system 100 includes an information processing apparatus 1 and a plurality of terminal apparatuses 2. While one information processing apparatus 1 and three terminal apparatuses 2 are shown in FIG. 1, the number of information processing apparatuses 1 and the number of terminal apparatuses 2 are not limited to those shown in FIG. 1. That is, the number of information processing apparatuses 1 may be any number equal to or greater than one, and the number of terminal apparatuses 2 may be any number equal to or greater than one.

The music production system 100 is a system capable of producing music by stacking tracks produced by users. The user is a person who uses the music production system 100. The user is, for example, a professional, a semi-professional, an amateur musician, or the like. The user may be a student at a music school or the like, or may be a person who enjoys listening to music as a personal hobby, or the like. This is merely an example, and the attribute of the user is arbitrary.

The information processing apparatus 1 and the plurality of terminal apparatuses 2 are connected to each other via a network N. The network N is a wireless or wired communication line. The network N may be, for example, an internet line, a mobile telephone network, a wireless Local Area Network (LAN), or a wired LAN, and the type of the communication is not limited. The information processing apparatus 1 is an apparatus that executes information processing according to this embodiment. The information processing apparatus 1 is, for example, a Personal Computer (PC). The information processing apparatus 1 may be implemented by a server device or a cloud system.

The terminal apparatus 2 is a terminal apparatus used by the user. The terminal apparatus 2 is, for example, a smartphone, a mobile telephone terminal, a tablet terminal, or a PC. The terminal apparatus 2 transmits, for example, a track produced by the user to the information processing apparatus 1 via a predetermined website open to users. The terminal apparatus 2 may transmit the track produced by the user to the information processing apparatus 1 via an application installed on the terminal apparatus 2 in advance. For example, the terminal apparatus 2 transmits the track to the information processing apparatus 1 by posting the track on the website.

The information processing apparatus 1 accepts the posting of the produced track from each of a plurality of users and connects the plurality of tracks based on a derivative relationship among the tracks, thereby producing music. The information processing apparatus 1 draws a tree diagram visually showing a process for producing the music, and causes the tree diagram that it has drawn to be displayed on a display unit provided in the terminal apparatus 2. The tree diagram is also called a tree structure diagram. The tree diagram includes at least a node(s) and a branch(es) as components. The node(s) indicates one or more tracks produced by a user(s). The branch(es) indicates a line segment(s) connecting between the nodes. Accordingly, the branch(es) indicates a derivative relationship between the tracks.

In the following description, two tracks which have a derivation relationship may be referred to as a derivation source track and a derivation destination track. The derivation source track is a track posted before the derivation destination track which has a derivation relationship with the derivation source track. Likewise, the derivation destination track is a track posted later than the derivation source track which has a derivation relationship with the derivation destination track. It can also be said that the derivation source track is a track that the user who has posted the derivation destination track has selected as a target on which the derivation destination track is to be stacked. The derivation source track may have a derivation relationship with a plurality of derivation destination tracks. Further, another track may be derived from the derivation destination track. In this case, the derivation destination track serves as a derivation source track when viewed from the other track that is further derived.

When a track is posted, the information processing apparatus 1 draws a node indicating the posted track. Further, when a new track to be stacked on the track has been posted, the information processing apparatus 1 draws a node corresponding to the new track. The information processing apparatus 1 connects the node that is newly drawn and a node that has been drawn in advance by a branch. Accordingly, the tree diagram expresses that the track that has been posted in advance (derivation source track) and the newly posted track (derivation destination track) have a derivation relationship.

Each time a track is posted, the information processing apparatus 1 repeats the aforementioned processing and increases the numbers of nodes and branches. At a predetermined stage, the information processing apparatus 1 completes one piece of music using a plurality of tracks and releases the completed music. Accordingly, the tree diagram can express the process in which the music is produced by a plurality of users.

Further, the information processing apparatus 1 accepts not only a posting from an individual user but also a posting from a group. The group is formed of a plurality of users who use the music production system 100. The group is composed of, for example, band members, students in the same class at a music school, or a plurality of users with similar music preferences. This is merely an example, and attributes of the users that compose the group are arbitrary. The group members (hereinafter they may be simply referred to as “members”) may be determined in advance before music production is started or may change during a time from the start to the end of music production. For example, the number of members may be increased or decreased in the middle of the music production.

The information processing apparatus 1 performs different processing for a case in which it has accepted a posting that does not use a group (hereinafter this posting may be referred to as a “normal posting”) and a case in which it has accepted a posting that uses a group (hereinafter this posting may be referred to as a “posting to a group”). Specifically, when the information processing apparatus 1 has accepted the normal posting, the information processing apparatus 1 makes the content of the posting open to all the users. When the information processing apparatus 1 has accepted the posting to the group, the information processing apparatus 1 makes the content of the posting open to only the group members. Accordingly, the posting to the group is only open to members and is not open to the public. When there is a posting to the group, the members can check this posting, which is not open to the public, and share their opinions and thoughts on the track, thereby enabling the members to participate in the track production in the group.

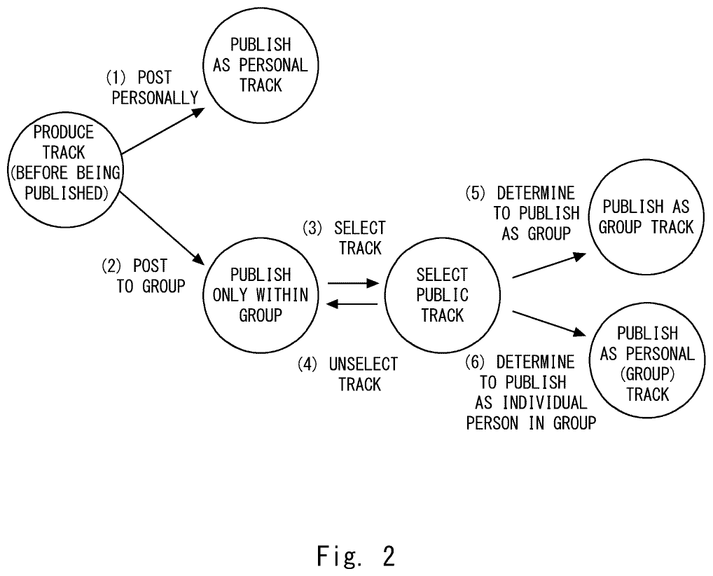

Now, with reference to FIG. 2, an outline of a method for publishing a track in the music production system 100 will be described. FIG. 2 is a diagram showing a flow from a time when a track is produced to a time when it is published on the tree diagram. The state of the track at each stage is shown inside each circle. As will be described below, there are three methods for publishing the produced track on the tree diagram.

### First Method

The first method is a method for publishing a posted track as a user's personal track when a user has performed a normal posting.

### Second Method

The second method is a method for publishing a posted track as a group track when a user has performed a posting to a group.

### Third Method

The third method is a method for publishing a posted track as a personal track in the group when a user has performed a posting to a group.

With reference to FIG. 2, the above three publishing methods will be described. First, the user produces a track using a predetermined application or the like. As shown in the leftmost part in FIG. 2, at a stage at which a track is produced, the track is not open to public yet. The user posts a track on a predetermined website provided by the information processing apparatus 1 via the terminal apparatus 2. When a track is produced by an individual user, the process proceeds to the processing in the upper stage. When a track is produced by a group, the process proceeds to the processing in the lower stage.

In the processing in the upper stage, the user posts the track personally (1). In this case, the information processing apparatus 1 publishes the posted track on the website as a user's personal track. This publishing method corresponds to the aforementioned first method. The information processing apparatus 1 draws a node indicating the posted track, draws a tree diagram using the node that it has drawn, and displays the tree diagram on the website. The information processing apparatus 1 may draw a tree diagram by associating the node indicating the track with user information on the user who has produced the track.

When the user belongs to a group, as will be shown in the processing in the lower stage, the user may post the produced track to the group (2). In this case, the information processing apparatus 1 makes the posted track open only within the group. The members can have conversations about the track posted to the group using a chat function that the information processing apparatus 1 has. The chat function may be, for example, a text chat or a voice chat. The user may correct the track based on the reaction and the like in the chat and post the corrected track again.

Each member selects the track to be published on the tree diagram (hereinafter this track may be referred to as a “public track”) from the plurality of tracks posted by members. The member selects the public track using a chat function or the like (3). The public track may be determined by a representative in consideration of, for example, the content of chat conversations, or may be determined by a vote. The member may unselect the public track that has once been selected (4). In this way, one or more public tracks are selected in the group.

Next, the members determine the method for publishing the selected public track. The information processing apparatus 1 publishes the public track in various forms depending on the determined publishing method. For example, the members determine to publish the public track as a group (5). In this case, the information processing apparatus 1 publishes the public track as a group track. This publishing method corresponds to the aforementioned second method. The information processing apparatus 1 draws a tree diagram by associating, for example, the node indicating the track with group information on the group that has produced the track. Accordingly, a user who sees the tree diagram can easily know that the public track has been produced in the group.

Further, the members may determine that the public track is to be published as an individual person in the group (6). In this case, the information processing apparatus 1 publishes the public track as a personal track in the group. This publishing method corresponds to the aforementioned third method. The information processing apparatus 1 draws a tree diagram by associating, for example, the node indicating the track, the user information, and the group information with one another. Accordingly, a user who sees the tree diagram can easily know that the public track has been produced by a user who belongs to the group.

### Configuration of Information Processing Apparatus 1

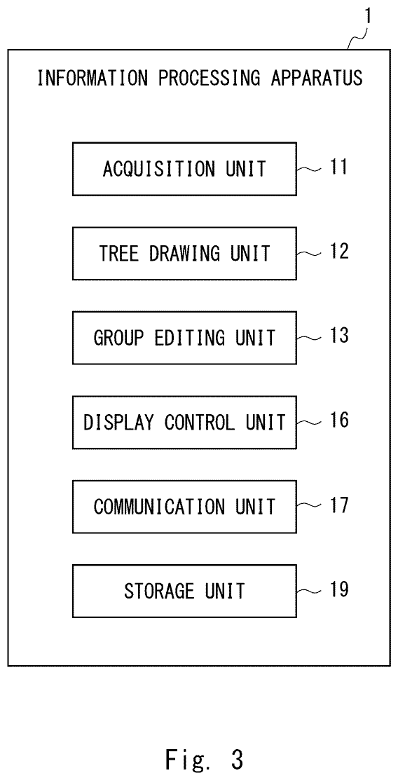

Next, with reference to FIG. 3, a configuration of the information processing apparatus 1 will be described. FIG. 3 is a block diagram showing a functional configuration of the information processing apparatus 1. The information processing apparatus 1 includes an acquisition unit 11, a tree drawing unit 12, a group editing unit 13, a display control unit 16, a communication unit 17, and a storage unit 19.

The information processing apparatus 1 includes a processor and a memory as components that are not shown. The storage unit 19 composed of a storage apparatus stores a computer program in which processing according to this embodiment is implemented. The processor can load the computer program from the storage device into the memory and execute this computer program. In this way, the processor implements the functions of the acquisition unit 11, the tree drawing unit 12, the group editing unit 13, and the display control unit 16. Each of the acquisition unit 11, the tree drawing unit 12, the group editing unit 13, and the display control unit 16 may be implemented by dedicated hardware.

Further, some or all of the components of the information processing apparatus 1 may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), a quantum processor (quantum computer control chip), and so on may be used as the processor.

Further, when some or all of the components of the information processing apparatus 1 are implemented by a plurality of information processing apparatuses, circuits, etc., the plurality of information processing apparatuses, circuits, etc., may be disposed in one place in a centralized manner or disposed in a distributed manner. For example, the information processing apparatuses, circuits, etc. may be implemented in a form of a client-server system, a cloud computing system, etc., each of which is connected through a communication network. The functions of the information processing apparatus 1 may be provided in the form of Software as a Service (SaaS).

The acquisition unit 11 acquires a plurality of tracks used for music production. The acquisition unit 11 acquires, for example, the tracks from the plurality of respective terminal apparatuses 2 via the network N. The acquisition unit 11 acquires respective tracks corresponding to a normal posting and a posting to the group. The acquisition unit 11 may acquire a plurality of tracks from one terminal apparatus 2. For example, when a plurality of postings are made to one group from one terminal apparatus 2, the acquisition unit 11 acquires tracks corresponding to the respective postings. The acquisition unit 11 may acquire the tracks via a predetermined website.

Note that the “track” indicates audio data produced by a user or a group. The track may be an audio data track such as recorded data of tones of instruments, or recorded data of human singing voices. Further, the track may be audio data generated by a computer. The track may be, for example, a Musical Instrument Digital Interface (MIDI) track including MIDI data and information on a MIDI sound source, or may be a VOCALOID (registered trademark) track generated by a VOCALOID technology. The track composes a part of a completed music. The track may be composed of one section, or may be composed of a plurality of sections. When the track is composed of a plurality of sections, the track may include sections such as a verse, a pre-chorus, and a chorus. The track may have a length shorter than one section.

The acquisition unit 11 stores data including the acquired tracks in the storage unit 19 as track data. The track data may include, besides audio data indicating the track, user information, group information, track information or the like.

The user information is information on a user who has produced a track. The user information may be, for example, a user name, a user nickname, or the like. The group information is information on the group that has produced the track. The group information may be, for example, a group name, a group abbreviation, or the like. The track information is information on the produced track. The track information includes, for example, information on instruments used in the performance. The track information may include various kinds of information such as the date and time the track is posted, the taste of the track, or the role of the track in the completed music.

The tree drawing unit 12 draws a tree diagram with the tracks acquired in the acquisition unit 11 as nodes. When, for example, the track is published using the aforementioned first method, the tree drawing unit 12 draws a tree diagram with the track posted by the user as a node.

Further, the tree drawing unit 12 draws a tree diagram based on one or more public tracks selected by the group editing unit 13. When, for example, the track is published using the aforementioned second method, the tree drawing unit 12 draws one or more public tracks selected by the group editing unit 13 collectively as one node by the group. Further, when the track is published using the aforementioned third method, the tree drawing unit 12 draws each of one or more public tracks selected by the group editing unit 13 as one node.

Specifically, the tree drawing unit 12 generates display information to be displayed on the display unit 22 of the terminal apparatus 2, and transmits the generated display information to the terminal apparatus 2, thereby drawing a tree diagram on the display unit 22 of the terminal apparatus 2. For example, the tree drawing unit 12 generates a tree diagram including, as components, at least nodes indicating tracks, and a branch indicating a derivative relationship among the plurality of tracks by connecting among the plurality of nodes. For example, the tree drawing unit 12 generates a tree diagram in such a way that the plurality of nodes which have a derivation relationship are connected like a form of beads on a string. The tree drawing unit 12 transmits the generated tree diagram to the terminal apparatus 2 via the communication unit 17.

The components of the tree diagram are not limited to nodes and branches. The components may each be a text, graphics, an image, or the like related to the track indicated by the node. The components may include, for example, user information on the user who has produced the track or track information on the track. Further, the tree drawing unit 12 may generate various kinds of buttons for reproducing or downloading the track. The tree drawing unit 12 transmits the generated display information to the terminal apparatus 2.

The group editing unit 13 edits a plurality of tracks that are shared among a group including a plurality of users and are derived from a certain track in such a way that the plurality of tracks are not open to the outside of the group. The editing of the tracks performed by the group editing unit 13 includes selecting one or more tracks from a plurality of tracks. The editing of the tracks also includes producing one track by stacking a plurality of tracks. This is merely an example, and the editing of the tracks may include editing of various tracks regarding music production.

The group editing unit 13 selects one or more public tracks to be open to the outside of the group from among the plurality of tracks edited in such a way that the plurality of tracks are not open to the outside of the group. The public track may be selected manually or may be selected automatically. When the public track is manually selected, the group editing unit 13 accepts, for example, input of the track to be selected as the public track from the group members.

For example, the group editing unit 13 selects the public track using a chat function or the like. The group editing unit 13 selects the track determined by conversations among members as the public track. For example, the group editing unit 13 may select the public track by accepting, from a representative of the group, the input of the public track that has been determined.

When the track is automatically selected, the group editing unit 13 specifies a track that satisfies a predetermined condition and selects the specified track as the public track. The predetermined condition may be set as desired. The predetermined condition may be, for example, that the number of votes cast by members is equal to or greater than a predetermined number or that the number of votes is high. The group editing unit 13 may select, using Artificial Intelligence (AI) or the like, a public track that many members agree with based on the content of chat conversations. The chat function and the voting function may be functions provided only for the group members.

For efficient selection of the public track, the group editing unit 13 may have a function of stacking certain tracks selected from a plurality of tracks that are candidates for the public track and synchronously reproducing the obtained track. For example, the group editing unit 13 accepts selection of certain tracks from the terminal apparatus 2 and causes a melody obtained by stacking these tracks to be output from the voice output unit 23 of the terminal apparatus 2. The group editing unit 13 may further stack tracks outside the group to output the obtained track. Accordingly, the group editing unit 13 can reproduce the music by stacking tracks inside and outside the group, whereby the user can easily select the public track while trying out combinations of various kinds of tracks.

The group editing unit 13 may generate a members-only page that can only be viewed by the members and cause the members-only page to be displayed on the terminal apparatus 2. The group editing unit 13 may perform selection of the public track or the like on this members-only page. Accordingly, the group editing unit 13 can set the posting to the group and the process of selecting the public track so that it is not open to people who are not the members. Accordingly, the members can listen to a new track, which is not open to the public, and view detailed information on the track. Further, while the example in which all the members select the track has been described above, this is merely an example. The group editing unit 13 may generate the selected-members-only page for enabling only some of the users among the members to select a track.

The group editing unit 13 may cause the the storage unit 19 to store information on track production in the group. For example, the group editing unit 13 causes the storage unit 19 to store tracks which are in the process of being produced. Accordingly, the group editing unit 13 can keep a record of production activities in the group, including tracks that have not been selected for the public track.

The display control unit 16 controls the display of the display information in the terminal apparatus 2. For example, the display control unit 16 causes the display unit 22 of the terminal apparatus 2 to display the tree diagram. Further, the display control unit 16 causes the display unit 22 to display the members-only page.

Further, when, for example, a node has been selected on the tree diagram by a click operation or the like of the user, the display control unit 16 may cause detailed information on this node to be displayed. When, for example, one node in which public tracks are bundled has been selected, the display control unit 16 may cause one or more tracks included in this node to be displayed on the tree diagram. For example, the display control unit 16 causes this node in association with one or more tracks included in this node to be displayed in a form such as speech bubbles. The display control unit 16 may cause this node and details of this node to be displayed in the vicinity of each other, or may cause them to be displayed on pages different from each other.

The communication unit 17 communicates with the terminal apparatus 2. For example, the communication unit 17 receives the track produced by the user from the terminal apparatus 2. Further, for example, the communication unit 17 transmits display information generated by the tree drawing unit 12 to the terminal apparatus 2. The communication unit 17 may be composed of a communication interface for performing communication by a wire or wirelessly.

The storage unit 19, which is composed of a semiconductor memory, stores various kinds of data and a program. At least a part of the storage unit 19 is composed of a non-volatile memory so that data is held therein even after the information processing apparatus 1 is turned off. The storage unit 19 stores, for example, the generated display information or the like.

### Configuration of Terminal Apparatus 2

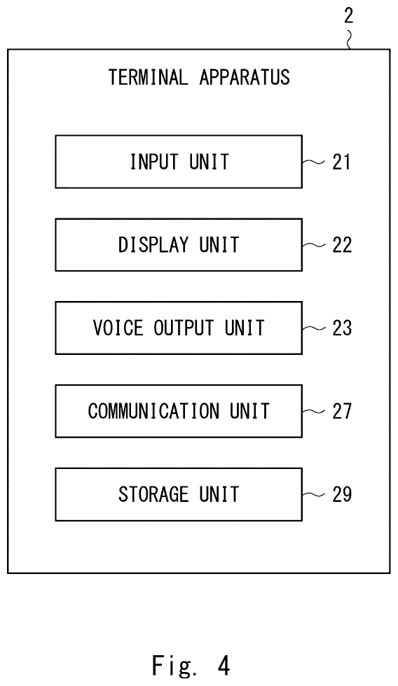

Next, with reference to FIG. 4, a configuration of the terminal apparatus 2 will be described. FIG. 4 is a block diagram showing a functional configuration of the terminal apparatus 2. The terminal apparatus 2 includes an input unit 21, a display unit 22, a voice output unit 23, a communication unit 27, and a storage unit 29.

The input unit 21 accepts user's input in accordance with an operation by a user in the terminal apparatus 2. For example, the input unit 21 produces a track in accordance with the user's operation. Further, the input unit 21 posts a track produced by the user on a predetermined website via the communication unit 27. The user may produce, for example, a track using a Digital Audio Workstation (DAW) application or the like.

The input unit 21 may include, for example, a keyboard, a mouse, a track ball, or a stylus pen. The input unit 21 may include a microphone or a camera. That is, the input unit 21 may include a voice input function or an image input function. This is merely an example, and another input device may be used as the input unit 21.

The display unit 22 displays information on music production. The display unit 22 is, for example, a display apparatus such as a display. The display unit 22 may be a touch panel or the like that includes a function of the input unit 21. That is, the input unit 21 and the display unit 22 may be integrally formed. The display unit 22 displays display information generated in the information processing apparatus 1. The display unit 22 displays, for example, the tree diagram and the members-only page.

The voice output unit 23 outputs information on music production by voice. The voice output unit 23 is, for example, a speaker. The voice output unit 23 outputs voice corresponding to the components selected in the tree diagram. For example, when a node has been selected, the voice output unit 23 reproduces the track corresponding to the node.

Further, when a system indicating the music has been selected, the voice output unit 23 reproduces the music corresponding to the system. The voice output unit 23 reproduces the track or the music in accordance with the range in which the track is published. For example, the voice output unit 23 outputs the voice of the track that is open only within the group to these group members, and does not output the voice to people who are not the group members.

The communication unit 27 communicates with the information processing apparatus 1. For example, the communication unit 27 transmits a track produced by the user to the information processing apparatus 1. Further, for example, the communication unit 27 receives the display information generated in the information processing apparatus 1. The communication unit 27 may be composed of a communication interface for performing communication by a wire or wirelessly.

The storage unit 29, which is composed of a semiconductor memory or the like, stores various kinds of data and a program. At least a part of the storage unit 29 is composed of a non-volatile memory so that data is held therein even after the terminal apparatus 2 is turned off. The storage unit 29 may store a produced track. Further, the storage unit 29 may store downloaded music or the like.

Each of the configurations of the music production system 100 according to this embodiment has been described above. The configuration of the aforementioned music production system 100 is merely an example, and may be changed as appropriate. For example, described above is the example in which the information processing apparatus 1 generates display information and transmits the generated display information to the terminal apparatus 2, whereby the terminal apparatus 2 displays display information. However, this is merely an example.

For example, the music production system 100 may perform processing according to this embodiment via a web application. In this case, the information processing apparatus 1 implements a web application that executes processing according to this embodiment. Further, the terminal apparatus 2 stores (installs) a web browser for displaying a page of a predetermined website in the storage unit 29. The terminal apparatus 2 executes a part of the processing according to this embodiment via the web browser displayed in the display unit 22.

For example, the terminal apparatus 2 performs a part of the processing of the aforementioned acquisition unit 11, tree drawing unit 12, group editing unit 13, and display control unit 16 via a web browser. For example, the terminal apparatus 2 displays a tree diagram and reproduces music on the web browser by a web application stored in the storage unit 19 of the information processing apparatus 1.

### Tree Diagram Drawing Processing

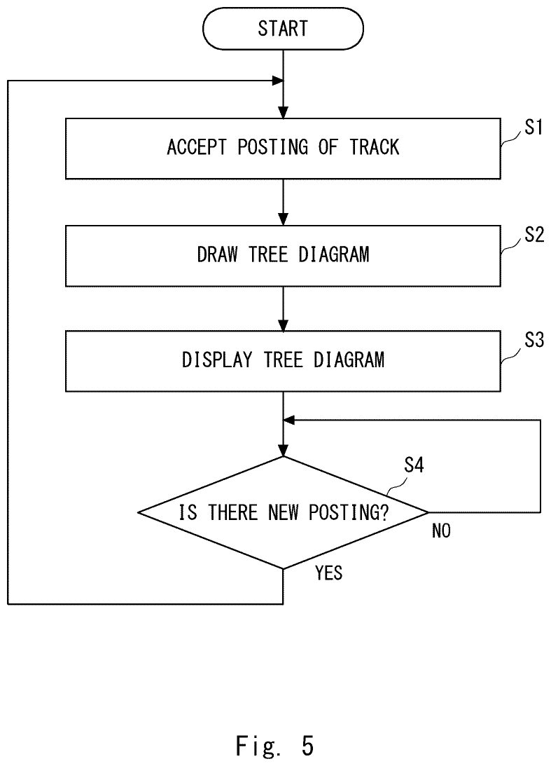

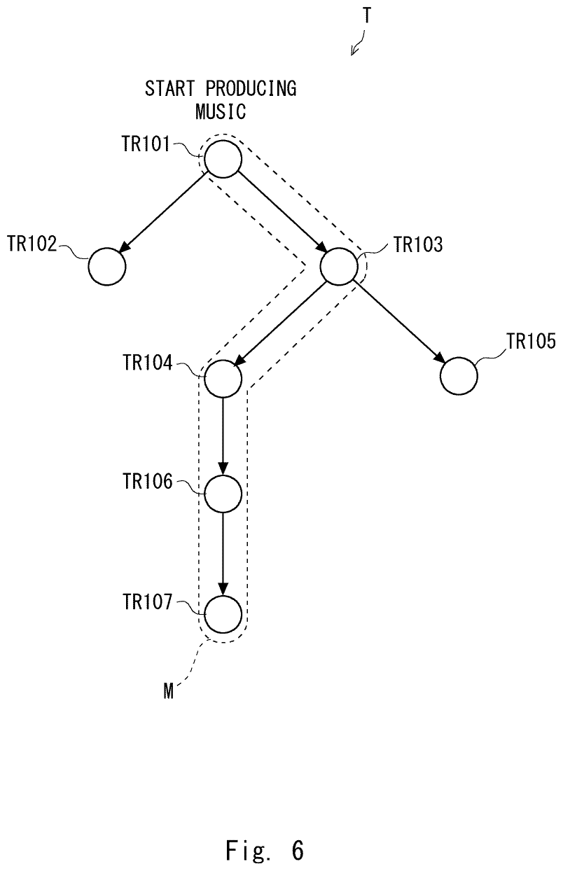

Next, with reference to FIGS. 5 and 6, basic processing performed by the information processing apparatus 1 will be described. FIG. 5 is a flowchart showing a flow of tree diagram drawing processing performed by the information processing apparatus 1. FIG. 6 shows one example of a basic tree diagram T drawn in the tree diagram drawing processing performed by the information processing apparatus 1.

First, the acquisition unit 11 accepts a posting of a track from the terminal apparatus 2 (S1). It is assumed here, as an example, that the acquisition unit 11 has accepted a posting of a track TR101 produced by a user A. The user A produces the track TR101 using the terminal apparatus 2, and posts the produced audio data to a website as the track TR101, thereby posting the track. The acquisition unit 11 stores the track TR101 in association with the track information in the storage unit 19 as track data. The track data includes, for example, a node number, a track number, a user name, an instrument name, and audio data.

The node number is a number for identifying the node. The node number may be automatically assigned to the node indicating the track when the track is added. The track number is a number for identifying the track. The track number may be automatically assigned to the track when the track is added.

The user name is information indicating the name of the user. The user name may be an account name or a nickname used by the user. Further, the user name may be an identification number automatically assigned. The instrument name is information indicating the name of an instrument used in the performance. The instrument name may be registered, for example, from the terminal apparatus 2 by the user or may be determined by the information processing apparatus 1 based on the melody of the track.

The audio data is data indicating the content of the track. The audio data may be recorded data of tones of instruments or may be recorded data of human singing voices or the like. Since they are merely examples, the track data may not include some of these information items or may include other information. The track data may include, for example, the date and time the track is posted, or the like. The track data may also include the name of the group which the user belongs to, or the like.

Next, the tree drawing unit 12 draws a tree diagram T (S2). At this timing, only the track TR101 of the user A is posted. Therefore, the tree drawing unit 12 draws the tree diagram T having only the node indicating the track TR101 as a component. The tree drawing unit 12 may draw the tree diagram T after two or more tracks are posted. The display control unit 16 may cause the tree diagram T to be displayed on the website (S3). Accordingly, the display unit 22 of the terminal apparatus 2 of the user displays the tree diagram T.

FIG. 6 shows one example of the tree diagram T. FIG. 6 also shows nodes indicating other tracks that are added later. The circles in FIG. 6 indicate nodes, and the arrows connecting the nodes indicate branches. The direction of each arrow indicates a derivative relationship. While not shown in FIG. 6, the tree diagram T may include information on instruments, or the like. For example, characters, graphics, or the like indicating items such as “guitar” may be displayed in proximity to the nodes. The same holds true for the following diagrams.

It is assumed, for example, that the node of the user A has been selected by the user by clicking or the like. The display control unit 16 reproduces the track TR101 in response to the node of the user A being selected. Then, users other than the user A can also listen to the track TR101. Further, the users can produce tracks to be stacked on the track TR101.

Referring is made once again to FIG. 5. The tree drawing unit 12 determines whether or not there is a new posting (S4). When it is determined that there is no new posting (NO in S4), the tree drawing unit 12 waits until there is a new posting. When it is determined that there is a new posting (YES in S4), the information processing apparatus 1 returns to Step S1, and the following processing is repeated.

For example, in the example shown in FIG. 6, in response to the track TR101 of the user A, a user B posts a track TR102 of a piano, and a user C posts a track TR103 of drums.

Further, in response to the track TR103 of the user C, a user D posts a track TR104 of a bass, and a user E posts a track TR105 of a saxophone. Further, in response to the track TR104 of the user D, a user F posts a track TR106 of a piano. Then, a user G posts a track TR107 by mixing the tracks TR101, TR103, TR104, and TR106 respectively posted by the users A, C, D, and F. The tree drawing unit 12 draws a tree diagram T by connecting the plurality of posted tracks based on a derivative relationship among the tracks.

For example, in a mixing phase, the user G can have conversations, using a chat function, with the users A, C, D, and F who have posted the tracks. For example, the user G communicates with the users A, C, D, and F regarding the mixing operation, and the users A, C, D, and F can replace tracks or post additional tracks to complete music. Finally, the music is completed when the user G posts the mixed track TR107. The track TR107 is a master track in which the tracks TR101, TR103, TR104, and TR106 are aggregated. In FIG. 6, the system M shown by a dashed line indicates the system of the completed music.

### Track Publishing Processing

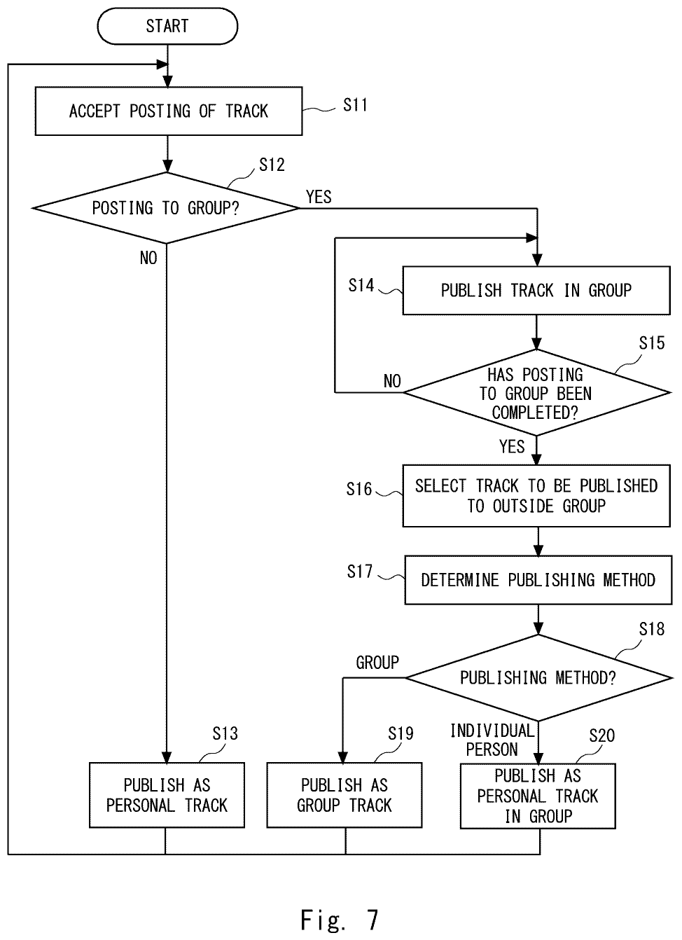

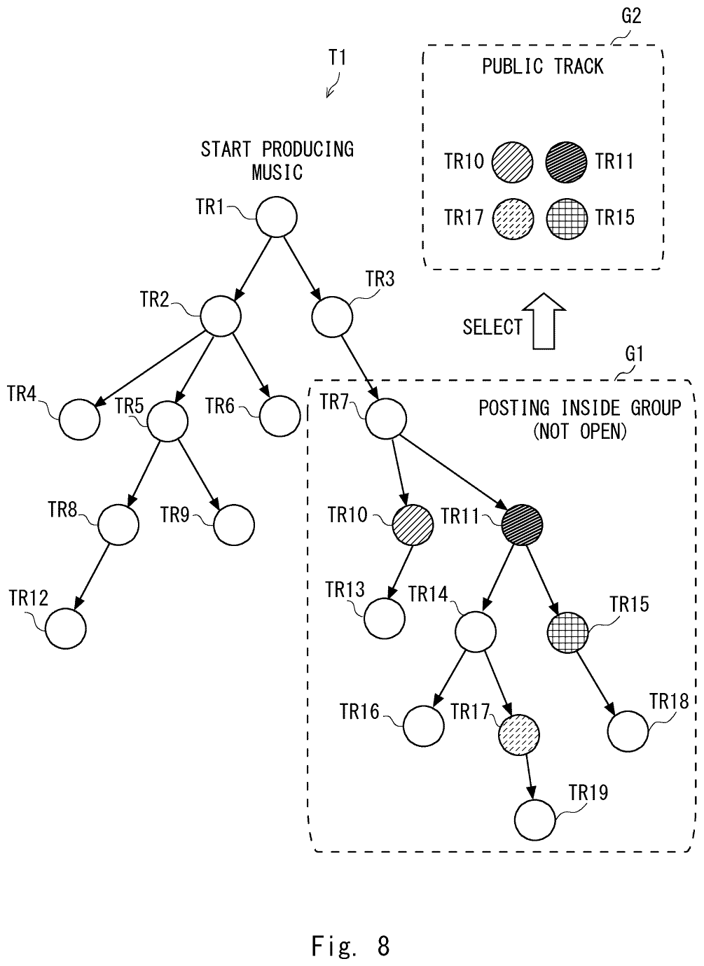

Next, with reference to FIGS. 7-10, track publishing processing performed by the information processing apparatus 1 will be described. FIG. 7 is a flowchart showing a flow of track publishing processing performed by the information processing apparatus 1. FIGS. 8-10 each show one example of a tree diagram for describing track publishing processing.

Hereinafter, a flow of track publishing processing will be described with reference to the flowchart in FIG. 7, and specific examples of the tree diagram will be described with reference to FIGS. 8-10 as appropriate. It is assumed that the information processing apparatus 1 constantly performs basic processing described with reference to FIGS. 5 and 6.

First, the acquisition unit 11 accepts a posting of a new track from the terminal apparatus 2 (S11). Next, the acquisition unit 11 determines whether or not the accepted posting is a posting to a group (S12). When it is determined that the accepted posting is not a posting to a group (NO in S12), the tree drawing unit 12 publishes the new track as a personal track (S13). This publishing method corresponds to the aforementioned first method. Specifically, the tree drawing unit 12 connects, by a branch, the node corresponding to the new track and a track from which this node is derived, and draws a tree diagram. Accordingly, the tree drawing unit 12 publishes the new track in the tree diagram.

FIG. 8 shows one example of a tree diagram T1 drawn in the tree drawing unit 12. In the tree diagram T1 in FIG. 8, nodes indicating respective tracks TR1-TR3, TR4-TR6, TR8-TR9, and TR12 are published as personal tracks.

Referring is made once again to FIG. 7. When it is determined that the posting of the new track is a posting to a group (YES in S12), the group editing unit 13 publishes the track in the group (S14). Since the group editing unit 13 makes the track open only to the group members, information on this track is not open to the people who are not the members. For example, the group editing unit 13 generates a members-only page that can only be viewed by members and causes the members-only page to be displayed on the display unit 22 of the terminal apparatus 2. Accordingly, the members can listen to a new track which is not open to the public and view detailed information on this track.

In the tree diagram T1 shown in FIG. 8, the track group posted to the group is shown as a track group G1. The track group G1 includes tracks TR7, TR10-TR11, and TR13-TR19. The track TR7 is a track derived from the track TR3 that is not included in the track group G1. The track TR3, and the track TR1, which is above the track TR3, etc. are open to people who are not the members as well, whereas the track TR7, and the tracks TR10-TR11 and TR13-TR19 that are derived from the track TR7, are not open to people who are not the members.

Referring is made once again to FIG. 7. Next, the group editing unit 13 determines whether or not the posting to the group has been completed (S15). For example, the group editing unit 13 causes the terminal apparatus 2 to display a button or the like for entering information indicating that the posting to the group has completed, and determines that the posting to the group is completed when the button is pressed. When it is determined that the posting to the group has not completed (NO in S15), the process returns to Step S14, where processing is repeated. When it is determined that the posting to the group has completed (YES in S15), the group editing unit 13 selects a public track to be open to the outside of the group (S16). For example, the group editing unit 13 selects a track using a chat function or the like. Note that “open to the outside of the group” may correspond to posting the selected public track as a new track.

In the example shown in FIG. 8, the public track group selected from the track group G1 is shown as a track group G2. The track group G2 includes four tracks of the tracks TR10, TR11, TR15, and TR17.

Referring is made once again to FIG. 7. Next, the group editing unit 13 determines the method for publishing the public track (S17). Specifically, the group editing unit 13 determines whether to publish the public track as a group track or as a personal track in the group. The group editing unit 13 may cause members to determine, for example, the publishing method using a chat function, or may cause the user who has produced the public track or a representative of the group to select the publishing method. When a plurality of public tracks have been selected, the group editing unit 13 may determine different publishing methods for different public tracks.

The tree drawing unit 12 determines which publishing method has been determined (S18). The tree drawing unit 12 publishes the public track in accordance with the determined publishing method. When it is determined that the public track is to be published as a group track (“group” in S18), the tree drawing unit 12 publishes the public track as the group track (S19). This publishing method corresponds to the aforementioned second method.

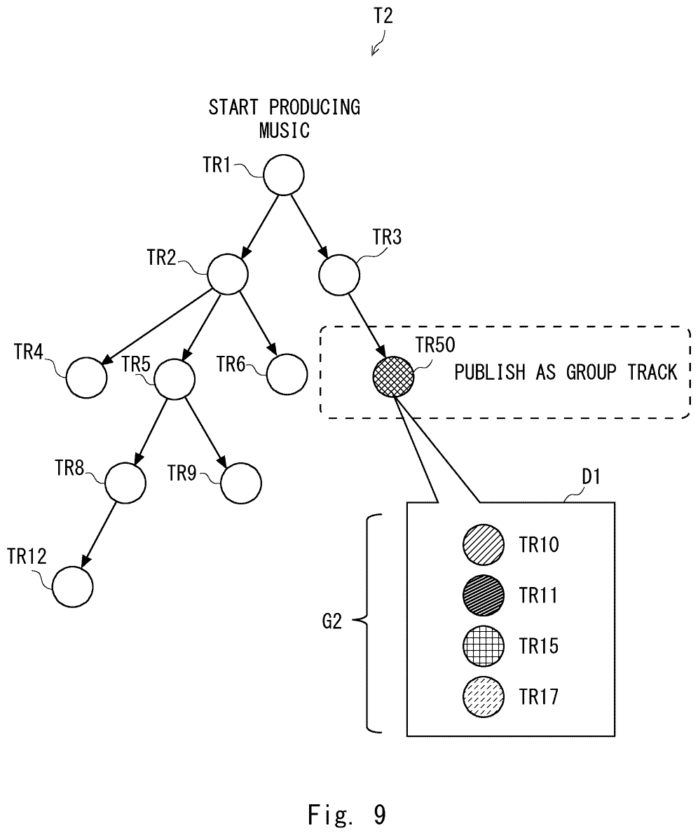

FIG. 9 shows one example of a tree diagram T2 when the public track is published as a group track. The tree diagram T2 includes, in place of the track group G1 in FIG. 8, a track group G2 formed of public tracks. However, the tree drawing unit 12 draws the track group G2 selected by the group editing unit 13 collectively as one node. In FIG. 9, this one node is a node indicating the track TR50. The track TR50 is a track obtained by stacking the melodies of the tracks TR10, TR11, TR15, and TR17 included in the track group G2.

The tree drawing unit 12 may draw the tree diagram T2 by associating the node indicating the public track with group information regarding a group that has produced the public track. The group information is, for example, a group name or the like. The tree drawing unit 12 may draw the tree diagram T2 so as to display detailed display D1 of the track TR50 when, for example, the track TR50 is clicked on the tree diagram T2. The tree drawing unit 12 may include, for example, the characters such as “produce: group X” in the detailed display D1.

Since the tracks TR10, TR11, TR15, and TR17 are treated as one node, when the user newly produces a track derived from the track TR50, the track TR50 serves as a derivation source track. The user may not be able to select a part of the track TR50 (e.g., the track TR10) as a derivation source track. This is only an example, and this limitation may be adjusted as desired.

Referring is made once again to FIG. 7. When it is determined that the public track is to be published as a personal track in the group (“personal” in S18), the tree drawing unit 12 publishes the public track as a personal track in the group (S20). This publishing method corresponds to the aforementioned third method.

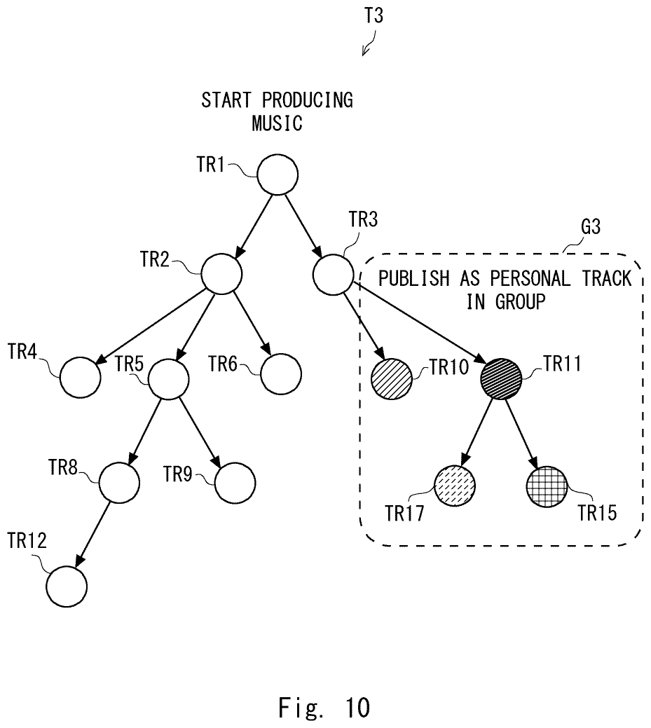

FIG. 10 shows one example of a tree diagram T3 when the public track is published as a personal track in the group. The tree drawing unit 12 draws the tracks TR10, TR11, TR15, and TR17, which are public tracks, in the tree diagram T3 as a track group G3. The track group G3 includes the tracks TR10, TR11, TR15, and TR17, like the track group G2.

The tree drawing unit 12 may draw the tree diagram T3 while maintaining the arrangement of each node in the tree diagram T1 shown in FIG. 8 as much as possible. For example, as shown in FIG. 10, in the track group G3 of the tree diagram T3, the arrangement of the public tracks TR10, TR11, TR15, and TR17 in the track group G1 of the tree diagram T1 is maintained to some extent.

For example, the tree drawing unit 12 maintains the derivative relationship between public tracks and arranges nodes based on this derivative relationship. For example, in the track group G3, the track TR7 that is not selected as a public track is excluded. Therefore, the tree drawing unit 12 connects the track TR3 from which the track TR7 is derived to the tracks TR10 and TR11, which are the destination of the derivation of the track TR7. The direction of the arrows indicating the branches is from the track TR3 to the tracks TR10 and TR11.

Accordingly, the tree drawing unit 12 maintains the derivative relationship indicating that the track TR3 is a derivation source and the track TR10 is a derivation destination while excluding the track TR7. Likewise, the tree drawing unit 12 maintains the derivative relationship between the track TR3 and the track TR11.

While tracks are derived in a system shown in the order of the tracks TR11, TR14, and TR17 in the track group G1, the track TR14 that is not selected as a public track is excluded in the track group G3. Therefore, the tree drawing unit 12 connects the track TR11 to the track TR17 in the track group G3. The direction of the arrow indicating the branch is from the track TR11 to the track TR17. Accordingly, the tree drawing unit 12 maintains the derivative relationship between the track TR11 and the track TR17.

Further, while each of the tracks TR13, TR16, TR18, and TR19 serves as a terminal end in the tree diagram T1 in the track group G1, the tracks TR13, TR16, TR18, and TR19 are not selected as the public tracks in the track group G3. Therefore, the tree drawing unit 12 does not draw the tracks TR13, TR16, TR18, and TR19 in the track group G3, and each of the tracks TR10, TR15, and TR17 serves as a terminal end in the tree diagram T3.

Further, the tree drawing unit 12 may maintain the right and left arrangement of nodes on the tree diagram T3. For example, the arrangement and the right and left positional relationship of the tracks TR10 and TR11 in the track group G1 are maintained in the tree diagram T3. The tree drawing unit 12 may draw the tree diagram T3 in such a way that the appearance of the track group G1 becomes similar to that of the track group G3.

As described above, the tree drawing unit 12 maintains the derivative relationship of each track before and after the selection of public tracks. Further, the tree drawing unit 12 maintains the vertical and horizontal arrangement (i.e., top, down, right, and left) of nodes on the tree diagram T3 as much as possible before and after the selection of public tracks. This configuration can enable the members to easily compare the track group G1 with the track group G3. Accordingly, the members can easily know, on the tree diagram T3, which tracks in the track group G1 have been selected as the public tracks.

Further, the tree drawing unit 12 may draw the tree diagram T3 by associating the nodes indicating the public tracks, the user information, and the group information with one another. For example, the tree drawing unit 12 may draw the tree diagram T3 in such a way that the group name, and the user name of the user who has produced each track are displayed in the vicinity of each of the tracks TR10, TR11, TR15, and TR17. The tree drawing unit 12 may display these information items in accordance with the user's node selection, like in the detailed display D1 in FIG. 9. For example, the tree drawing unit 12 may cause the letters such as “Produced as the user Y of the group X” to be displayed.

Further, as shown in FIG. 10, the tree drawing unit 12 may draw the track group G3 and nodes other than the track group G3 in such a way that they are differentiated from each other by surrounding the track group G3 by a frame. The track group G3 is not limited to being surrounded by the frame, and the tree drawing unit 12 may differentiate them in any display form. For example, the tree drawing unit 12 may differentiate them by using a display form such as color, text, or an image. For example, the tree drawing unit 12 may make a background color of an area around the track group G3 different from that of the other area.

Unlike the track TR50 in FIG. 9, in the tree diagram T3 in FIG. 10, each of the tracks TR10, TR11, TR15, and TR17 is published. Therefore, the user can select one of the tracks TR10, TR11, TR15, and TR17 as a derivation source track, and post a new track to be stacked on the selected track. Accordingly, the tree drawing unit 12 can improve the degree of freedom of track production by users in the group or outside the group while expressing, on the tree diagram T3, that each track in the track group G3 has been produced in the group.

Since the tree diagrams shown in FIGS. 8-10 are examples, the form of the tree diagram can be changed as appropriate. While the example in which the posting to the group is started from the track TR7, which is in the middle of the tree diagram T1, has been used in the aforementioned description, the posting to the group may be started from the root node (corresponding to the track TR1) of the tree diagram T1.

Further, the tree drawing unit 12 may draw, for example, a node indicating that the track is being produced in the group in the vicinity of the track group G1 during the time in which the track group G1 is open to the group only. The tree drawing unit 12 draws, for example, a node including the letters such as “music is being produced”. The tree drawing unit 12 may draw this node in a form that is suitable for advertisement. For example, the tree drawing unit 12 may make the appearance of this node a photograph of a music jacket. Further the tree drawing unit 12 may draw this node by highly visible colors and display forms on the tree diagram T1 so that it attracts user's interest.

As described above, with the music production system 100 according to the present disclosure, the information processing apparatus 1 acquires a plurality of tracks, and draws a tree diagram with the acquired tracks as nodes. The information processing apparatus 1 edits a plurality of tracks that are shared among a group including a plurality of users and are derived from a certain track in such a way that these tracks are not open to the outside of the group. The information processing apparatus 1 selects, for example, one or more public tracks to be open to the outside of the group from among the plurality of tracks edited so that they are not open to the outside of the group. Accordingly, the information processing apparatus 1 draws a tree diagram based on the one or more selected public tracks.

Accordingly, the information processing apparatus 1 can select a public track representing the group from among the tracks that members have produced privately, and post and publish the public track. Accordingly, users can freely produce music in the group using the service provided by the music production system 100.

According to the aforementioned configuration, the music production system 100 according to the present disclosure can appropriately publish a track produced in a group. Further, the user can publish only the completed track produced as the group without showing tracks which are being produced. Further, since the information processing apparatus 1 can keep a record of tracks which are being produced, the user can use this record as well.

Note that the present disclosure is not limited to the above-described embodiments and may be changed as appropriate without departing from the spirit of the present disclosure. While the system for producing music has been used in the aforementioned description, the present disclosure is not limited to being applied to music production and may be limited to other objects that can be produced like a form of beads on a string. The present disclosure can be applied, for example, to the fields of digital art, video, games, or the like.

Each functional component of the information processing apparatus 1 and the terminal apparatus 2 described above may be implemented by hardware (e.g., a hard-wired electronic circuit, etc.) for implementing each functional component, or by a combination of hardware with software (e.g., a combination of an electronic circuit with a program for controlling the same, etc.) For example, the present disclosure may implement desired processing by causing a CPU to execute a computer program.

The program includes instructions (or software codes) that, when loaded into a computer, cause the computer to perform one or more of the functions described in the embodiments. The program may be stored in various types of non-transitory computer readable media or tangible storage media. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on various types of transitory computer readable media or communication media. By way of example, and not a limitation, transitory computer readable media or communication media can include electrical, optical, acoustical, or other forms of propagated signals.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above. Furthermore, it is noted that, Applicant's intent is to encompass equivalents of all claim elements, even if amended later during prosecution.

What is claimed is:

1. An information processing apparatus comprising:
an acquisition unit configured to acquire a plurality of tracks;
a tree drawing unit configured to draw a tree diagram with the tracks as nodes; and
a group editing unit configured to edit a plurality of tracks that are shared in a group including a plurality of users and are derived from a certain track in such a way that the plurality of tracks are not open to an outside of the group, wherein
the group editing unit selects one or more public tracks to be open to the outside of the group from among the plurality of tracks edited in such a way that the plurality of tracks are not open to the outside of the group, and
the tree drawing unit draws the tree diagram based on the one or more public tracks selected by the group editing unit.

2. The information processing apparatus according to claim 1, wherein the tree drawing unit draws the one or more public tracks selected by the group editing unit collectively as one node by the group.

3. The information processing apparatus according to claim 1, wherein the tree drawing unit draws each of the one or more public tracks selected by the group editing unit as one node.

4. An information processing method comprising:
an acquisition step of acquiring a plurality of tracks;
a tree drawing step of drawing a tree diagram with the tracks as nodes; and
a group editing step of editing a plurality of tracks that are shared in a group including a plurality of users and are derived from a certain track in such a way that the plurality of tracks are not open to an outside of the group, wherein
in the group editing step, one or more public tracks to be open to the outside of the group are selected from among the plurality of tracks edited in such a way that the plurality of tracks are not open to the outside of the group, and
in the tree drawing step, the tree diagram is drawn based on the one or more public tracks selected in the group editing step.

5. A non-transitory computer readable medium storing a program, the program causing a computer to execute:
an acquisition step of acquiring a plurality of tracks;
a tree drawing step of drawing a tree diagram with the tracks as nodes; and
a group editing step of editing a plurality of tracks that are shared in a group including a plurality of users and are derived from a certain track in such a way that the plurality of tracks are not open to an outside of the group, wherein
in the group editing step, one or more public tracks to be open to the outside of the group are selected from among the plurality of tracks edited in such a way that the plurality of tracks are not open to the outside of the group, and
in the tree drawing step, the tree diagram is drawn based on the one or more public tracks selected in the group editing step.
